(19) United States
(12) Patent Application Publication
(10) Pub. No.: US 2009/0300551 A1
(43) Pub. Date: Dec. 3, 2009

(54) INTERACTIVE PHYSICAL ACTIVITY AND INFORMATION-IMPARTING SYSTEM AND METHOD

(76) Inventors: Barry J. French, Bay Village, OH (US); MaryEllen French, Bay Village, OH (US)

Correspondence Address: Jonathan A. Platt;Renner, Otto, Boisselle & Sklar, LLP, 19th Floor, 1621 Euclid Ave., Cleveland, OH, 44115, US

(21) Appl. No.: 12/475,708

(22) Filed: Jun. 1, 2009

Related U.S. Application Data
(60) Provisional application No. 61/058,340, filed on Jun. 3, 2008.

(51) Int. Cl. G06F 3/048; G09B 19/00

(52) U.S. Cl. 715/848; 434/247

(57) ABSTRACT

A method of imparting information includes interactively selectively displaying information to a person or user, based on the physical location of the person relative to a display screen upon which the information is displayed. A tracking system is operatively coupled to the display that selectively displays the information. The tracking system tracks the physical location of the person, and displays different information depending upon the physical location of the person. The display may include displays of virtual objects, such as cubes or other shapes. The view of the objects may be varied within the display as the user moves within physical space, varying the apparent position of the virtual objects as the user moves. The varying of the apparent position of the virtual objects may reveal information that was not visible to the user in other virtual positions (corresponding to other physical positions of the user).

This application claims priority under 35 USC 119 to U.S. Provisional Application No. 61/058,340, filed Jun. 3, 2008, which is incorporated herein by reference in its entirety.

### TECHNICAL FIELD OF THE INVENTION

The invention relates to systems for kinesthetic learning processes, systems involving both information imparting and physical movement.

### BACKGROUND OF THE INVENTION

Some learners benefit from education utilizing kinesthetic processes, in that they learn better when the learning task involves movement that enables manipulation of objects. Such kinesthetic learners preferentially involve their whole bodies in their activities. For such individuals the educational experience is enhanced by use of educational activities that involve physical movement, such as whole-body movement. Even for students who do not learn best by kinesthetic methods, learning is often enhanced through multisensory experiences that combine body motion with traditional visual and auditory methods of delivering information.

In particular, children often learn most effectively when they have to actively “grapple” with information and have their “hands on” the materials. Indeed, many children learn best through direct experience and experimentation.

Cognitive research reiterates the significant value of children's play to their cognitive and motor development. In such play children in essence learn effectively through observation and direct manipulation of their environments. It is expected that brain development is enhanced by simultaneously engaging different cognitive functions simultaneously. Such simultaneous engagement of different cognitive functions is particularly useful for learning and retaining educational material. For instance a student that reads material aloud engages both auditory and visual cognitive functions, and may be expected to retain the material better than if exposed to it only visually (through reading silently), or auditorially (through having the material read to him or her).

From the above it is seen that education or learning is enhanced by engaging multiple cognitive functions, including kinesthetic learning.

FIG. 1 shows a prior art system that involves kinesthetic learning, a system described in U.S. Pat. No. 6,749,432. FIG. 1 shows an education system 700 that synergistically enhances the learning process by including a kinesthetic approach to learning which preferably causes a heightened metabolic rate. The education system 700 includes a tracking system 702 for tracking a student 704 (also a “subject” or “person”) as he or she moves in a defined physical space 708. The tracking system 702 is operatively coupled to a display 710 which displays information that prompts the subject 704 to engage in a cognitive learning task. A reflector or beacon 712 is provided on the subject or student 704 to enable the tracking system 702 to track him or her. This tracking allows the student's position within the physical space 708 to be monitored. The education system 700 prompts the student 704 to engage in full-body movement so as to raise his or her metabolic rate. The display and task may involve updating in real time a view of a virtual space, the updating being made in response to movements of the student or subject 704 within the physical space 708. The task may involve displaying cognitive learning elements, such as elements 716 and 718, on the display 710 for viewing by the subject 704. The task may also involve movement through the virtual space of a student icon 720 representing the subject or student 704. The exemplary cognitive learning task illustrated in FIG. 1 involves the solving of arithmetic problems.

### SUMMARY OF THE INVENTION

According to an aspect of the invention, a kinesthetic learning system provides a view of a virtual space, wherein the view includes selectively revealed information that is revealed dependent upon physical movement and/or position of a user.

According to another aspect of the invention, an information imparting system includes placing information (such as letters, words, or numbers) on parts of virtual objects that are concealed or revealed as a function of physical movement and/or position of a user.

According to yet another aspect of the invention, a method of interactively imparting information to a person includes the steps of: tracking body location of the person; and displaying to the person a view of a virtual space that includes one or more virtual objects. The displaying includes varying the view based on the body location of the person, such that the varying includes varying the apparent position of the one or more virtual objects in the virtual space, as perceived by the person. The varying the view includes selectively displaying information on the one or more virtual objects, based on the body location of the person.

To the accomplishment of the foregoing and related ends, the following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings, which are not necessarily to scale:

FIG. 1 is a representation of a prior art kinesthetic learning system;

FIG. 2 is a representation of an interactive physical activity and information-imparting system in accordance with an embodiments of the present invention;

FIG. 3 shows a display screen of the system of FIG. 2, displaying a first view of virtual space, shown when a user is in a central position in a physical space;

FIG. 4 shows the display screen of FIG. 3, displaying a second view of virtual space, shown when the user is in a position off to one side in the physical space;

FIG. 5 shows the display screen of FIG. 3, displaying a second view of virtual space, shown when the user is in a position off to the other side in the physical space; and

FIG. 6 shows a representation of a display system in accordance with another embodiment of the present invention.

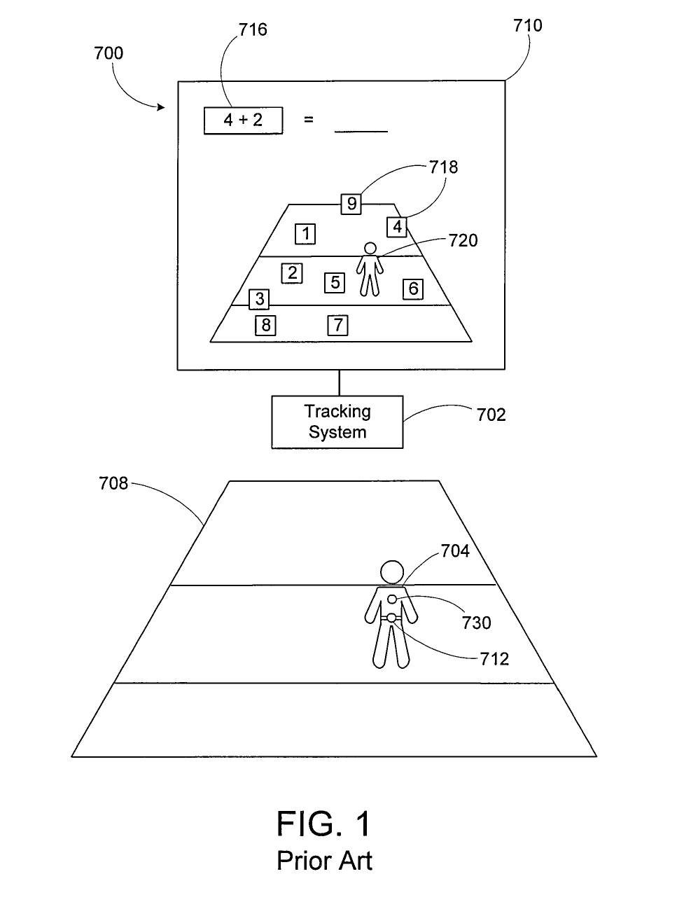

### DETAILED DESCRIPTION

A method of imparting information includes interactively selectively displaying information to a person or user, based on the physical location of the person relative to a display screen upon which the information is displayed. A tracking system is operatively coupled to the display that selectively displays the information. The tracking system tracks the physical location of the person, and displays different information depending upon the physical location of the person. The display may include displays of virtual objects, such as cubes or other shapes. The view of the objects may be varied within the display as the user moves within physical space, varying the apparent position of the virtual objects as the user moves. The varying of the apparent position of the virtual objects may reveal information that was not visible to the user in other virtual positions (corresponding to other physical positions of the user). For instance information (such as words, numbers, or letters) on a side surface of virtual cubes may be visible to the user only when the user is in certain physical positions away from the center of a physical space in front of the display.

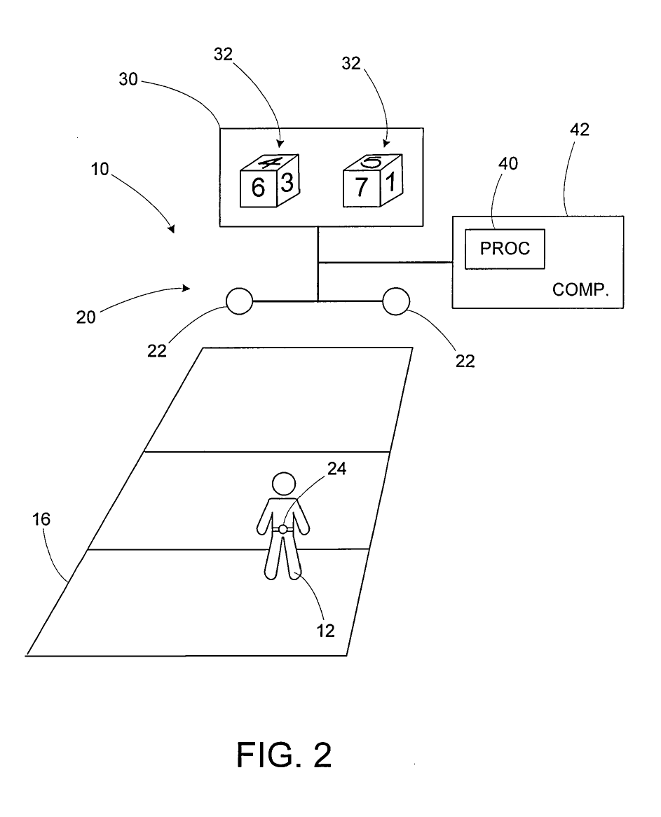

Referring to FIG. 2, an interactive system 10 is used for prompting a kinesthetic learning or education experience for a user or person 12 (also referred to herein as a “player”). The person 12 moves within a physical space 16, which may be a two-dimensional or three-dimensional space, with or without well-defined boundaries. Motion of the user 12 within the physical space 16 is detected using a tracking system 20. The tracking system 20 may include one or more sensors 22 to detect motion of a reflector or beacon 24 worn by or attached to the user 12, to track physical motion of the user 12.

The mechanism for tracking physical motion of the user 12 may include any of a wide variety of suitable mechanisms. Known electromagnetic, acoustic and video/optical technologies may be employed. Sound waves such as ultrasonic waves, or light waves in the visible or infrared spectra may be used in detecting motion. The reflector or beacon 24 may be an active device that actively sends out or emits signals that are detected by the one or more sensors 22. For example the beacon 24 may transmit infrared signals that are received or detected by the one or more sensors 22. An example of such infrared emitter and detector system is utilized in Nintendo's WII system, which uses a pair of infrared light emitting diodes (LEDs), and sensors (infrared cameras) for detecting light from the LEDs. In addition, it will be appreciated that the roles of the sensors 22 and the beacon 24 may be reversed, with the “sensors” 22 sending signals that are received and detected by the “beacon” 24 worn by or coupled to the user 12. In such a configuration the tracking system 20 would have one or more fixed beacons 22 that send signals received by one or more sensors 24 on the user 12.

Alternatively, the reflector or beacon 24 may be a passive device that reflects incoming signals to provide an indication of location. Such reflection may be of signals or waves transmitted by the tracking system 20 or from another location. The reflected signals may be configured for detection by the tracking system 20, for example being a specific wavelength.

The reflector or beacon 24 may be located at or near the center of mass of the user 12. For example the reflector or beacon may be attached to a belt which is worn about the waist of the user 12. Alternatively the reflector or beacon 24 may be located elsewhere on the user 12, for example being mounted on the head of the player, such as by being integrated with a hat or with eyeglasses. A head-mounted reflector or beacon 24 may have the advantage of providing better results in simulating apparent movement of the virtual objects.

As another alternative, the tracking system 20 may detect movement of the user 12 without the need for the user to wear a reflector and/or beacon. For example the tracking system 20 may include one or more cameras or other image-receiving devices, and image-processing hardware and/or software for detecting the location of the user, as well as for tracking changes in the physical location of the user.

Another possibility for the tracking system 20 is use of floor-mounted switches to detect presence and movement of the user 12. Pressure-activated switches may be placed at various locations throughout the physical space 16 for tracking the presence of the user 12 at those locations. It will be appreciated that any suitable number of such switches may be used. An example of use of pressure-activated digital switches are the floor pads used by Konami's DANCE DANCE REVOLUTION products, which have switches at certain locations which are marked on the pad.

One example of the tracking system 20 is the tracking system found in the CYBEX TRAZER trainer available from Cybex International, Inc., of Medway, Mass. Another example is an optical sensing system available as a modification of the DynaSight system from Origin Instruments of Grand Prairie Tex. Such a system uses a pair of optical sensors, i.e., trackers, mounted about 30 inches apart on a support mast centered laterally with respect to the physical space 16 at a distance sufficiently outside a front boundary to allow the sensors to track movement in the physical space 16. Further details regarding tracking systems and their operation may be found in U.S. Pat. No. 6,749,432, the description and drawings of which are incorporated herein by reference.

A display 30 is used to display to the user 12 a view of a virtual space or virtual world that includes one or more virtual objects 32. The display 30 may be any of a wide variety of monitors or other video displays, for example including cathode ray tube (CRT) displays, liquid crystal displays (LCDs), flat screen televisions or monitors, digital light processing (DLP) displays, plasma displays, projections displays, virtual reality goggles or headsets, or the like.

A processor 40 may be operatively coupled to the tracking system 20 and the display 30, for controlling the view of the virtual space that is shown on the display 30. The processor 40 utilizes information from the tracking system 20 in updating the view of the virtual space that is on the display 30. The processor 40 may be part of a computer 42 running appropriate software.

The computer 42 may retain a record of some or all of the data regarding the player's position on a data storage device such as hard disk or a writeable optical disk. This retained data may be in raw form, with the record containing the actual positions of the player at given times. Alternatively, the data may be processed before being recorded, for example with the accelerations of the player at various times being recorded.

It will be appreciated that the processor 40 may be configured to gather and store in the computer any of a wide variety of parameters regarding motion of the user 12. Such parameters may include (to give a few examples): a measure of work performed by the player, a measure of the player's velocity, a measure of the player's power, a measure of the player's ability to maximize spatial differences over time between the player and a virtual protagonist, a time in compliance, a measure of the player's acceleration, a measure of the player's ability to rapidly change direction of movement, a measure of dynamic reaction time, a measure of elapsed time from presentation of a cue to the player's initial movement in response to the cue, a measure of direction of the initial movement relative to a desired response direction, a measure of cutting ability, a measure of phase lag time, a measure of first step quickness, a measure of jumping or bounding, a measure of cardio-respiratory status, and a measure of sports posture. Details regarding such measures may be found in U.S. Pat. No. 6,308,565, the figures and description of which are incorporated herein by reference.

The system 10 determines the coordinates of the user (or player or subject) 12 in the physical space 16 in essentially real time and updates current position without any perceived lag between actual change and displayed change in location in the virtual space 30, preferably at an update rate in excess of about 20 Hz. A video update rate of approximately 30 Hz, with measurement latency less than 30 milliseconds, has been found to serve as an acceptable, real-time, feedback tool for human movement. However, the update rate may be even higher, in excess of about 50 Hz, or even more preferably in excess of 70 Hz.

The tracking system 20 allows the user 12 to interacting with the virtual space by moving within the physical space 16. The system 10 may engage the user 12 in a task that involves physical movement. The display and task may involve updating in real time a view of the virtual space, the updating being made in response to movements of the user 12 within the physical space 16. The task may involve displaying cognitive learning elements, such as the virtual objects 32. The cognitive learning elements may be symbolic elements, such as letters, numbers, or words. As explained in greater detail below, at least some parts of the elements may be initially hidden from the user 12, and/or may be revealed by certain physical movements by the user 12 (as detected by the tracking system 20).

Movement of the user 12, detected by the tracking system 20, may be used to alter the displayed view of the virtual space that is shown on the display 30. The processor 40 may be configured for rendering view-dependent images on the display 30, for example by use of appropriate software. In such a system the view on the display 30 reacts to movements of the user 12 as if the display 30 was a real window for viewing the virtual space. The changes in the display 30 create a realistic illusion of depth and space. For example movement of the user 12 toward the display 30 may increase the amount of the virtual space that is visible, just as moving closer to a window in the real world allows one to view more through the window frame. Movement of the user 12 to the left or right in the physical space causes a corresponding change in what is displayed on the display 30, just as physical movement toward the left or right sides of a window will change parts of the outside environment visible through the window. Similarly, movement of the user 12 vertically may change the view of the virtual world that is on the display 30. It will be appreciated that these rendering processes may allow for a realistic view of the virtual world or space.

The change of the view of the virtual space on the display 30 may include movement of the one or more virtual objects 32, and/or other changes in the appearance of the virtual objects 32. The virtual objects 32 may translate side-to-side and/or up-or-down in response to movements of the user 12 in the physical space 16. The amount of translation may be varied based on virtual locations of the virtual objects 32, within the virtual space. The size of the virtual objects 32 may change as well. For example, the objects may increase size as the user 12 moves closer to the display 30, and decrease size as the user 12 moves away from the display 30. In addition, the virtual objects 32 may tip or otherwise show different sides or aspects in response to the movement of the user 12. For example, movement to the right by the user 12 may cause right sides of the virtual objects 32 to be more visible, and left sides of the objects 32 to become hidden or less visible.

All or some of the above object appearance changes may create an illusion for the user 12 of space and depth in the view of the virtual world on the display 30. The virtual objects 32 may appear to be at different depth locations relative to the plane of the display screen 30. For example, foreground-appearing virtual objects may be larger than background-appearing objects, and may translate more as a result of side-to-side and/or up-and-down motion of the user 12. One or more of the virtual objects 32 may even be configured to appear forward of the plane of the display 30.

Software run on the processor 40 may be used to create the illusion of space and depth described in the previous paragraph. Such software is readily available for use on standard personal computers. An example of such software is the WiiDesktopVR program offered for download by Johnny Chung Lee at http://www.cs.cmu.edu/˜johnny/projects/wii/.

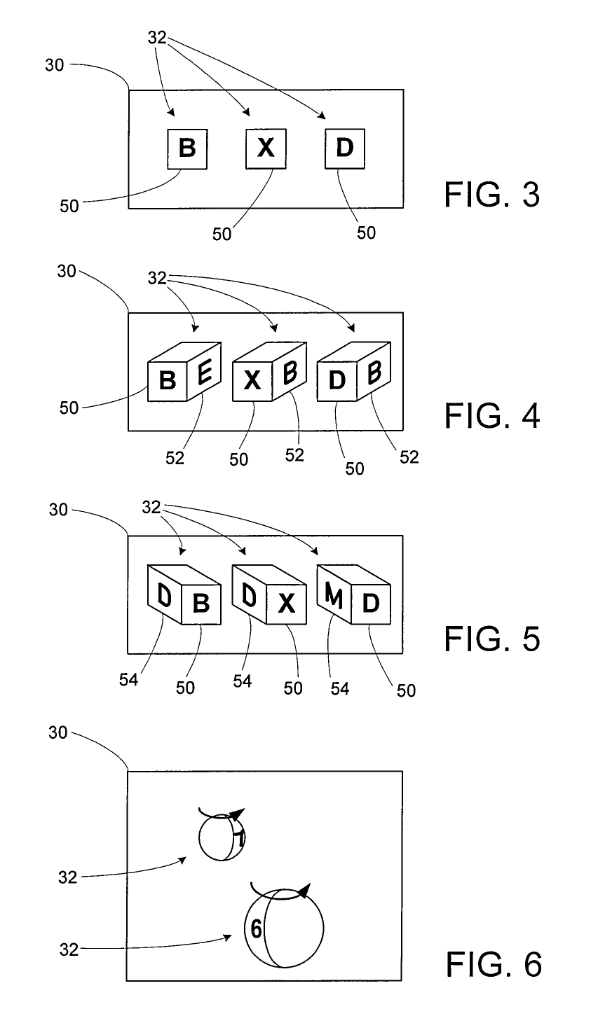

With reference now in addition to FIGS. 3-5, information may be strategically embedded on certain surfaces of virtual objects within the virtual environment such that the information is only viewable when the user 12 is in certain positions in the physical space 16. FIG. 3 shows a series of virtual objects 32 (cubes) as shown on the display 30 when the user 12 is in a center location within the physical space. Only the front surfaces 50 of the virtual cubes 32 are visible.

When the user 12 physically moves to his or her right side surfaces 52 of the virtual cubes 32 are revealed, as shown in FIG. 4. Movement of the user 12 to the left may produce the situation shown in FIG. 5. The side surfaces 52 that were previously visible are now hidden, while opposite side surface 54 are now visible.

Thus the user 12 may have to perform physical movement in order to see all of the information available on the virtual objects (the letters on the front surfaces 50 and the side surfaces 52 and 54). This feature or aspect may be utilized in an interactive physical activity educational task. To give one example, the user 12 may be prompted to find and select the virtual object 32 that has all the letters of the word “BED.” Such a prompt may be visual and/or aural. The user 12 then needs to move back and forth to see all of the side surfaces 52 and 54 of the objects 32. Then the user 12 may select the correct virtual cube 32 (the leftmost cube in FIGS. 3-5), for example by moving to a left side of the physical space 16 and jumping. The jumping would be detected by the tracking system 20 as user movement in a vertical direction. The task may be made more complicated by having the virtual cubes move forward or backward within the virtual space (appear to move toward and/or out of the display 30, or more away from and/or back into the display 30).

FIGS. 3-5 illustrate only one specific example of a wide variety of applications of the concept of having information in a virtual space that requires the user 12 to physically move to uncover or view. The virtual objects 32 may be any of a variety of geometric shapes, including cubes, spheres, discs, pyramids, parallelepipeds, etc. The virtual objects 32 may have more complicated shapes, such as representing numbers, letters, or various real-life objects such as toys, animals, or other tangible things. The virtual objects 32 may be stationary within the virtual space. Alternatively the virtual objects 32 may appear to move. The virtual objects 32 may translate (either in a single direction, or in multiple directions, for example moving back and forth), rotate, or spin. Appearance of the visual objects 32 may change over time. The visual objects 32, or parts of them, may pulsate, deform, blink on and off, and/or change colors.

The information on the virtual objects 32 may include letters, words, numbers, symbols such as geometric shapes, and/or colors, to give just a few examples. The information may be that involved in a cognitive learning task. The term “cognitive learning,” as used herein, is defined as learning that involves the attainment of abstract information that has general applicability outside of the learning task. Such information includes, for example, academic or scholastic material traditionally taught in schools. Examples of such academic information include multiplication tables and the content and order of the alphabet. “Cognitive learning” as used herein also includes learning other information, such as the steps of an industrial process. Cognitive learning broadly embraces learning involving mental concepts or skills, or speculative knowledge, which can be abstracted from the physical world and which has general applicability outside of the learning task.

Tracking and display systems such as those described above may be employed for use in kinesthetic educational learning tasks. Some learners benefit from education utilizing kinesthetic processes, and it is expected that brain development is enhanced by engaging different cognitive functions simultaneously. In addition, it is expected that learning may be enhanced by increases in the student's metabolic rate, such as increases in metabolic rate that result from the student's execution of learning task(s). Such increased metabolic rate may be due to an increase in the body's need, and subsequent delivery of, oxygen to support the production of energy in the body. It will be appreciated that increased metabolic rate due to increased activity can result in increased alertness. Thus increasing metabolic rate in a student can enhance a learning activity. However, numerous other factors—some as yet unidentified—for the observed enhanced learning state may be contributing.

Based on the user's physical location (X, Y, Z) within the physical space 16, exclusive visual information would be viewable by the user 12 as a direct consequence of his or her discrete position. Location-specific visual information selectively viewable based on the user's instantaneous physical location. Like the real world, the user or player 12 may, by shifting his physical position, would be able to “look around” or “at the side of” or “the top of” or “bottom of” the virtual objects 32 to discover exclusive visual information. For example, a virtual object in the shape of a cube traveling toward the foreground may have appear entirely blue because only its face (front surface) is viewable by the player. But by jumping up (elevating the sensing beacon 24), the player 12 would be in a position to view the top surface which may be actually green. Game strategies would prompt such exploration by the player or user 12.

Terminology such as “game” and “player” is accurate in the sense that the information-imparting or educational task may seem like a game to the user 12. Thus learning may be made fun. In addition the user 12 benefits from physical activity, as well as any benefitting from kinesthetic learning benefits.

As another example, each surface of a virtual object, such as a cube or sphere, could display unique information. The player 12 would have to move to the correct locations the physical space 16 to view the front, top, bottom and two side surfaces (the back would not be viewable unless the object was spinning) to view all the info displayed. Having access to all this embedded information could be essential to the strategy of the game or task.

As another example, each surface of a 3D virtual object could represent a part of the whole that provides the clues to satisfy/solve a game challenge. The virtual object could be FRISBEE-like flying disk floating with symbols on both sides viewable only by the player's elevation changes. The design of the game could have the object or objects stationary or moving.

Examples of controllable game or task parameters include: rate of transit of virtual object(s)—either at a constant velocity or the object's speed can vary over the distance traveled; vector of transit (background to foreground, diagonal, etc.) of the objects; shape of the objects (3D letters, numbers, geometric shapes, etc.); size of the objects; color of the objects; number of objects displayed; spin/rotation of the objects are they travel (for example, less spin means more speed or a change in direction during flight); presentation of objects in identifiable patterns for pattern recognition drills; and embedded position-specific visual information. The system may be configured such that movement of the user 12 may trigger changes in one or more of these parameters.

FIG. 6 illustrates another exemplary embodiment. Virtual objects 32 are continually transiting from background to foreground (as perceived by the user 12). The virtual objects 32 are shown as spinning spheres, but alternatively could be either be three-dimensional numbers or cubes with numbers on their various surfaces. The player can either “impact” or “avoid” the virtual objects 32 by physical movement within the physical space 16. At the start of each game, a number is presented on the display screen, for example shown at reference number 60. The objective of the game may be for the user 12 to impact as quickly as possible the virtual objects 32 whose assigned numbers total the present number. The impacting and avoiding may be accomplished by movement of the user 12 within the physical space 16, for example moving parallel to the display screen 30, perpendicular to the display 30 (toward and away from the display 30), and/or changing elevation (e.g., jumping and/or crouching).

For example, if the presented number is “21,” the user 12 proceeds to impact as quickly as possible those numbers that added together would total 21, while avoiding those virtual objects whose numbers, if impacted, would cause the player's total to exceed 21. Achieving 21 wins the game—secondary measures of success could be achieving a total in close proximity to the displayed number and elapsed time.

Alternative game or task objectives can require the player or user 12 to employ multiplication, subtraction or division to reach the presented number. Other variants have different numbers on different faces or parts of the virtual objects 32. The user 12 may have to navigating “around the virtual object” to find out the different numbers and/or to select this object. In other words, the user 12 may have to move physically within the physical space 16 to uncover information on the virtual object 32 that would not be available absent such movement. The surfaces may display numbers totaling greater than displayed number. Such an object, if selected, may cause the player to lose the game or lose points in a game score.

In a further alternative the virtual objects may be virtual cubes having different colors on each side. The user 12 may have to find an object with a particular color, or a particular pattern of colors. Or as another example a virtual cube (or other shape) may have letters on its faces or surfaces that do or do not spell an indicated or desired word.

It will be appreciated that the features described may be used in a variety of other context, such as sports simulations and entertainment games. Among the areas where such features may be applied are brain fitness training and sports vision training.

Brain fitness programs may be used to improve a foundation for learning and brain fitness by exercising the “muscles of your brain.” Improved mental processing, focus, concentration and working memory is the result. For students, this foundation enhances their ability to effectively learn from their classroom teachers.

Scientists report that there are two kinds of general intelligence: fluid intelligence and crystallized intelligence. Improving fluid intelligence, said to be the biological basis of intelligence, involves improving speed of reasoning, mental processing and memory. It is analogous to building a bigger, stronger, quicker athlete—building a more agile, focused and quicker processing brain. By contrast, crystallized intelligence is the knowledge and skills we've accumulated; analogous to the sport-specific skills taught by the coach.

Brain fitness programs may be used to improve the way users remember, learn, and attend to a task, to generally promote physical and mental agility More specifically, brain fitness tasks may be used to enhance the brain's processing efficiency by improving one or more of: working memory; visual tracking, perception, and scanning; visuospatial sequencing and classification; sustained, selective, alternating and divided attention; motor control and speed; processing speed; and conceptual reasoning.

Sports vision training (“VT”) methods may realistically depict the trajectory of a 3-dimensional object such as a volleyball or baseball in virtual space, for example to help train a player to derive directional information from the entire flight of the object. In sports such as baseball and tennis, milliseconds can determine success or failure; gleaning valuable info from the path the ball travels bestows a competitive edge. The ideal tool for a vision trainer would be a means for players to develop the experience/expertise demonstrated by elite athletes.

It is anticipated that with VT training, the coordination between the eyes, brain and body will improve. VT programs may present the player with a multitude of relevant visual cues, thereby requiring effective and rapid changes of focus and decision-making from a multiplicity of choices. The ability to recognize “patterns” of play as they develop should also be enhanced. Studies indicate that pattern recognition is a universal skill that is adaptive to all sports.

VT may offer one or more of the following benefits (among others): superior eye-tracking ability, due to the enhanced 3D effect and large physical movement area; training of realistic angles of pursuit/interception; sports training that is materially responsive to the athlete's perspective—it teaches and trains the importance of location/vantage point; the multiplicity of 3D objects develops visual search techniques to elicit the desired info; and it provides a true, novel perceptual-cognition-kinesthetic linkage (eyes, brain and core body linkage).

Research suggests that vision training can improve sports performance by improving focus, depth perception, peripheral awareness, reaction time as well as strengthening eye muscles. Even participants in less dynamic sports such as golf are purported to benefit from improved depth perception, visual memory, color perception and excellent eye-brain-body coordination.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of interactively imparting information to a person, the method comprising:
tracking body location of the person; and
displaying to the person a view of a virtual space that includes one or more virtual objects;
wherein the displaying includes varying the view based on the body location of the person, such that the varying includes varying the apparent position of the one or more virtual objects in the virtual space, as perceived by the person; and
wherein the varying the view includes selectively displaying information on the one or more virtual objects, based on the body location of the person.

2. The method of claim 1, wherein the method involves engaging the person in an academic learning task.

3. The method of claim 1, wherein the information is displayed on one or more surfaces of the one or more virtual objects that are not visible when the body location is at a location substantially centered relative to a display upon which the view of virtual space is displayed.

4. The method of claim 3, wherein one or more virtual objects include one or more cubes.

5. The method of claim 3, wherein at least some of the one or more surfaces are visible when the person moves sufficiently horizontally.

6. The method of claim 3, wherein at least some of the one or more surfaces are visible when the person moves sufficiently vertically.

7. The method of claim 3, wherein the displaying includes having the one or more virtual objects appear to spin.

8. The method of claim 1, wherein the information includes one or more numbers.

9. The method of claim 1, wherein the information includes one or more letters.

10. The method of claim 1, wherein the displaying includes rendering the view of the virtual space in response to changes in body location of the person detected by the tracking.

11. The method of claim 10, wherein the displaying includes shifting position of the one or more virtual objects in response to the changes in body location.

12. The method of claim 11, wherein the rendering and the shifting position are parts of creating an illusion for the person of space and depth in the view of the virtual world that is shown on the display.

13. The method of claim 1, wherein the interactively imparting information is a kinesthetic learning method.
